(19) United States
(12) Patent Application Publication
(10) Pub. No.: US 2024/0408548 A1
(43) Pub. Date: Dec. 12, 2024

(54) SYSTEMS AND METHODS FOR THE PRODUCTION OF ACID DEFICIENT URANYL NITRATE FROM A DILUTE URANYL NITRATE SOLUTION VIA DIFFUSION DIALYSIS AND VACUUM DISTILLATION

(71) Applicant: X-energy, LLC, Rockville, MD (US)

(72) Inventor: Alex TILTON, Knoxville, TN (US)

(73) Assignee: X-energy, LLC, Rockville, MD (US)

(21) Appl. No.: 18/735,908

(22) Filed: Jun. 6, 2024

Related U.S. Application Data
(60) Provisional application No. 63/472,048, filed on Jun. 9, 2023.

(51) Int. Cl. B01D 61/28; B01D 61/24; G21C 19/50; G21F 9/00

(52) U.S. Cl. CPC B01D 61/28; B01D 61/243; G21C 19/50; G21F 9/007; B01D 2311/2669; B01D 2311/2673

(57) ABSTRACT

Systems and methods for producing acid deficient uranyl nitrate from a dilute uranyl nitrate solution are disclosed. In one form, the present disclosure provides a system comprising a feed evaporation system and a diffusion dialysis system. The feed evaporation system is configured to receive a feed stream and to boil off water, under vacuum, from the feed stream to produce a concentrated uranyl nitrate solution and a distilled water product. The diffusion dialysis system is configured to counter flow the concentrated uranyl nitrate solution and the distilled water product across a plurality of membrane vessels to promote nitrate migration from the concentrated uranyl nitrate solution to the distilled water, and to produce a dialysate stream and a recycle acid stream. The feed stream may include a product of a solvent extraction process used to recycle spent nuclear fuel and/or a recovery stream from other fuel fabrication activities.

### RELATED APPLICATIONS

The present application claims priority to U.S. Provisional Patent Application No. 63/472,048, filed Jun. 9, 2023 (still pending), the entirety of which is hereby incorporated by reference.

The present invention was made with government support under DE-NE0009040 awarded by the Department of Energy. The government has certain rights in this invention.

### BACKGROUND

Acid deficient uranyl nitrate solutions are used in a solution gelation process for fuel fabrication. Acid deficient uranyl nitrate solutions regularly have a uranium concentration between 2.80 M to 3.27 M, a nitrate concentration 4.5 M to 5.25 M, a density 1.85 g/cc to 2.00 g/cc, and a NO3/U molar ratio 1.50 to 1.75.

Dilute uranyl nitrate solutions are produced as a result of solvent extraction from spent fuel reprocessing, from uranium recovery, or from off-specification fuel solutions. Dilute uranyl nitrate solutions may have a uranium concentration from less than 1 g/cc (<1 g/cc) and may have any nitrate concentration.

A typical process for producing acid deficient uranyl nitrate solutions from dilute uranyl nitrate solutions is to use direct denitration. This process produces a solid powder that must be redissolved to produce acid deficient uranyl nitrate solution and a NOx effluent that must be scrubbed from the gaseous exhaust.

In view of the foregoing, it would be desirable to have a process that allows for production of acid deficient uranyl nitrate from a dilute uranyl nitrate solution.

### SUMMARY

To address this need, the present disclosure provides systems and methods for the production of acid deficient uranyl nitrate from a dilute uranyl nitrate solution via diffusion dialysis and vacuum distillation.

A brief summary of various embodiments and implementations is presented below. Some simplifications and omissions may be made in the following summary, which is intended to highlight and introduce some aspects of embodiments and implementations disclosed herein, but not to limit the scope of the present disclosure. Detailed descriptions of embodiments and implementations adequate to allow those of ordinary skill in the art to make and use inventive concepts of the present disclosure will follow in later sections.

In one form, the present disclosure provides a system comprising a feed evaporation system and a diffusion dialysis system.

The feed evaporation system is configured to receive a feed stream and to boil off water, under vacuum, from the feed stream to produce a concentrated uranyl nitrate solution and a distilled water product.

The diffusion dialysis system is configured to accept the concentrated uranyl nitrate solution and the distilled water product; to counter flow the concentrated uranyl nitrate solution and the distilled water product across a plurality of membrane vessels to promote nitrate migration from the concentrated uranyl nitrate solution to the distilled water; and to produce a dialysate stream and a recycle acid stream.

In some implementations, the feed stream comprises a product of a solvent extraction process used to recycle spent nuclear fuel. However, in other implementations, the feed stream comprises a recovery stream from fuel fabrication activities other than a solvent extraction process used to recycle spent nuclear fuel.

In another form, the present disclosure provides a method comprising: boiling, at a feed evaporation system, under vacuum, water off from a feed stream to produce a concentrated uranyl nitrate solution and a distilled water product; and counter flowing, at a diffusion dialysis system, the concentrated uranyl nitrate solution and the distilled water product across a plurality of membrane vessels to promote nitrate migration from the concentrated uranyl nitrate solution to the distilled water, and producing a dialysate stream and a recycle acid stream.

In some implementations, the feed stream comprises a product of a solvent extraction process used to recycle spent nuclear fuel. However, in other implementations, the feed stream comprises a recovery stream from fuel fabrication activities other than a solvent extraction process used to recycle spent nuclear fuel.

### BRIEF DESCRIPTION OF THE DRAWINGS

In order to better understand the present disclosure, reference is made to the accompanying drawings, wherein:

FIG. 1 illustrates one form of a Feed Evaporation System.

FIGS. 2A to 2C illustrate one form of a Diffusion Dialysis System.

FIG. 3 illustrates one form of a Product Evaporation System.

FIG. 4 illustrates one form of a Recovery Evaporation System.

FIG. 5 illustrates one form of an overall system for producing acid deficient uranyl nitrate from a dilute uranyl nitrate solution.

### DETAILED DESCRIPTION OF THE DRAWINGS

Referring now to the drawings, in which like numerals refer to like components or steps, there are disclosed broad aspects of various exemplary embodiments and implementations.

The present disclosure is directed to system and methods for producing acid deficient uranyl nitrate from a dilute uranyl nitrate solution. In some implementations, the solution may be the product of a solvent extraction process used to recycle spent nuclear fuel or a recovery stream from other fuel fabrication activities.

Various embodiments and implementations disclosed herein further relate to a process for producing acid deficient uranyl nitrate from a dilute uranyl nitrate solution, including: a Feed Evaporation System, a Diffusion Dialysis System, a Product Evaporation System, and a Recovery Evaporation System.

As discussed in more detail below, a Feed Evaporation System boils off water under vacuum to produce a concentrated uranyl nitrate solution with excess acid and a distilled water product. In some implementations, a water recovery rate is adjusted based on a need of the Diffusion Dialysis System, with a balance discharged as clean water vapor. A vacuum is provided by a venturi and suppresses NOx production from the feed solution.

The Diffusion Dialysis System accepts the concentrate and distillate from the Feed Evaporation System and flows them counter-currently across a membrane stack to promote nitrate migration from the concentrate into the distillate. This produces a dialysate with a NO3/U molar ratio within the specification for acid deficient uranyl nitrate and a recycle nitric acid stream.

The dialysate is fed to the Product Evaporation System where the excess water is boiled off and the concentrate is acid deficient uranyl nitrate of acceptable concentration.

The recycle nitric acid stream is fed to the Recovery Evaporation System where the excess water is boiled off and a concentrated nitric acid is produced that is suitable for reuse in other processes.

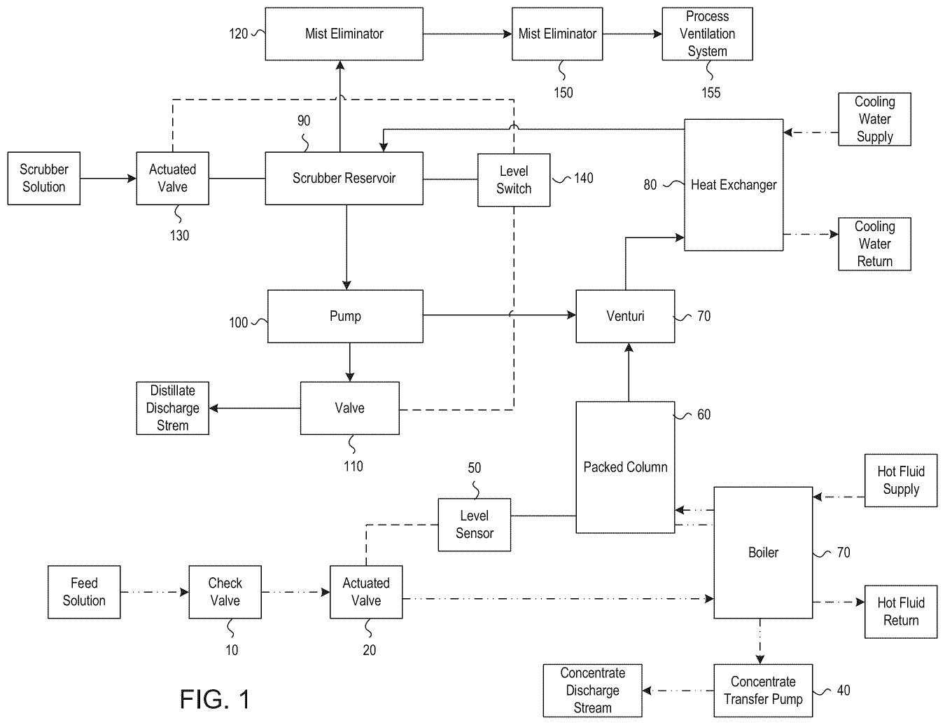

FIG. 1 illustrates one form of a Feed Evaporation System. In some implementations, a system for producing acid deficient uranyl nitrate from a dilute uranyl nitrate solution includes a check valve 10 that is configured to receive a feed solution and prevent the feed solution from backflowing to an origin vessel that provides the feed solution.

An actuated valve 20 is controlled by a level sensor 50. The actuated value 20 is configured to receive the feed solution from the check valve 10 and provide the feed solution to the boiler 30 until the level sensor 50 closes the actuated value. In some implementations, the level sensor 50 closes the actuated valve 20 when a level of feed solution in a packed column 60 reaches a predefined level of the level sensor 50.

In some implementations, the boiler 30 may be a shell and tube heat exchanger or a column with an immersion heater. In the case of a shell and tube heat exchanger, the feed solution flows into a shell side of the boiler 30 where it is heated by a heat transfer medium that flows counter currently through a tube side of the boiler 30. The heat transfer medium may be steam or hot oil that is at a temperature hot enough to induce boiling in the feed solution.

When the boiler 30 is a column with an immersion heater, the feed solution fills the column, and the level of feed solution is controlled such that the heating elements are always submerged.

In some implementations the boiler 30 is circulated by either a thermosiphon effect, or by an attached force-circulation pump that draws feed solution from a bottom of the boiler 30 and discharges feed solution at a top of the boiler 30. The concentrate is allowed to dwell in the boiler 30 until a desired concentration is reached, at which point concentrate is evacuated from the bottom of the boiler 30 via a concentrate transfer pump 40. Under steady state, a small flow of feed solution is entering and exiting the boiler 30 at all times such that the volume in the boiler 30 remains constant.

Vapor rises out of the boiler 30 and into the packed column 60. In some implementations, the packed column 60 is filled with a packing material such as Raschig rings or wire mesh that allows for more vapor/liquid contact and improves separation efficiency. Separated vapor, which is water with only trace amounts of nitric acid and uranyl nitrate, is sucked out of the packed column by a venturi 70. The venturi forms a first part of a vapor scrubbing portion of the system.

In some implementations, a scrubber portion of the system may include a scrubber reservoir 90 that is initially charged with fresh deionized water through actuated valve 130. Scrubber solution is pumped via pump 100 through a shell and tube heat exchanger 80 and back into the scrubber reservoir 90. A level switch 140 controls a level of scrubber solution in the scrubber reservoir 90. For example, when a level of scrubber solution gets too low in the scrubber reservoir 90, the actuated valve 130 is opened to fill it. Alternatively, when a level of scrubber solution in the scrubber reservoir 90 is too high, the level switch 140 actuates a valve 110 to open it and allows some amount of scrubber solution to discharge. In some implementations, the scrubber shell and tube heat exchanger 80 is connected to cooling water flowing through the tube side.

Vapor that is not condensed in the scrubber reservoir 90 passes through a mist eliminator 120 that catches any liquid droplets that may have formed. The vapor then passes through a duct heater 150 that ensures the vapor remains hot enough to not condense in the ventilation system. Finally, the heated vapor is discharged where it can go into the atmosphere as clean water vapor.

In some implementations, all vessels in this system are less than or equal to 5.56″ (≤5.56″) in outer diameter to maintain criticality control.

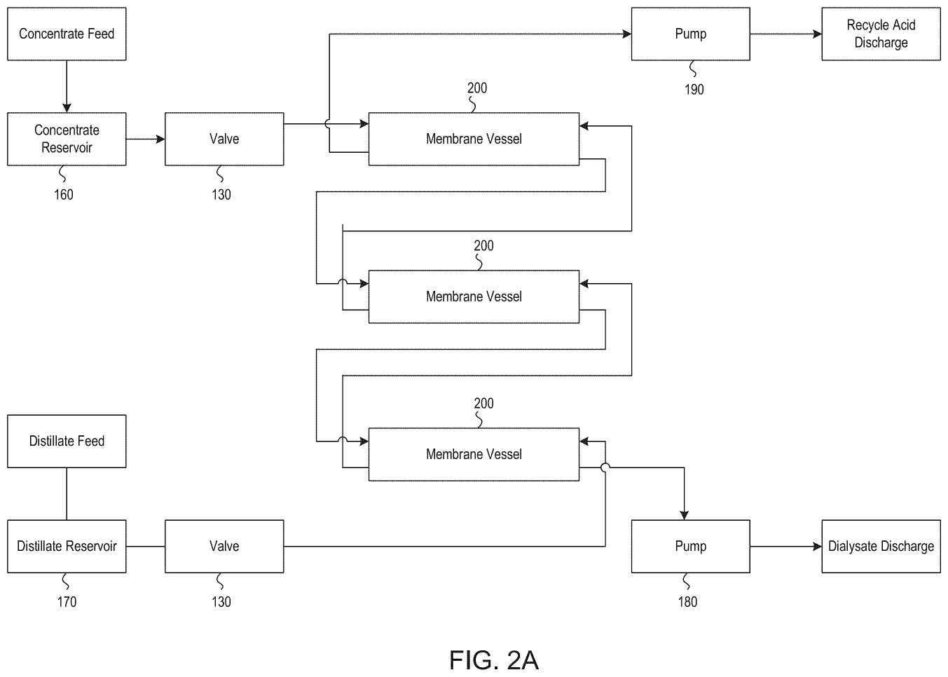

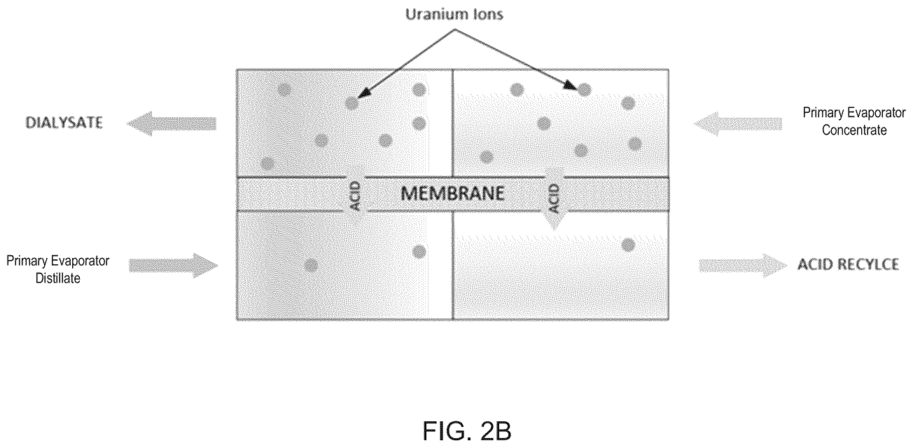

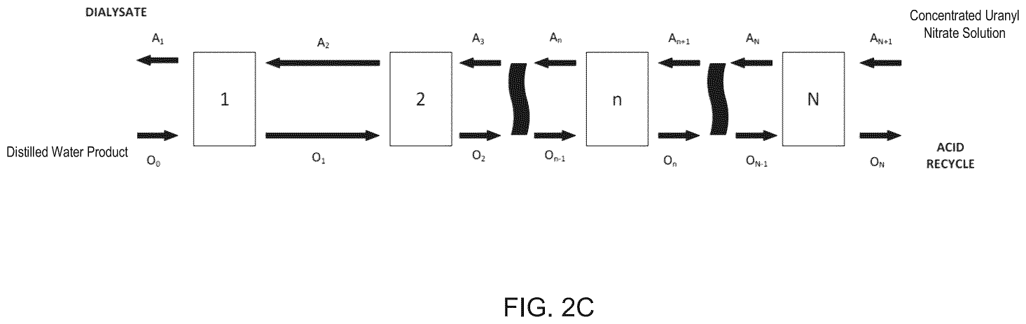

FIGS. 2A to 2C illustrate one form of a Diffusion Dialysis System. Referring to FIG. 2A, a concentrate from a Feed Evaporator System, such as the Feed Evaporator System described above in conjunction with FIG. 1, is fed to a Concentrate Reservoir 160. Additionally, captured distillate from a Feed Evaporator System, such as the Feed Evaporator System described above in conjunction with FIG. 1, is fed to the Distillate Reservoir 170.

Pumps 180 and 190 positioned at a discharge of membrane vessels 200 to control a flow through membranes 200. The concentrate flows from the concentrate reservoir 160, through a valve 130, and through one side of the membrane vessels 200 while the distillate flows counter currently from the distillate reservoir 170, through a valve 130, and through the other side of the membrane vessels 200. The membrane vessels 200 contain a spiral-wound anionic membrane that separates the vessel into channels.

FIG. 2B illustrates a process that occurs at a membrane interface within each membrane vessel 200. As illustrated in FIG. 2B, within each membrane vessel, a feed stream is separated from a deionized water stream by an anionic membrane. This membrane allows nitrate ions to pass through it, but the membrane prevents the uranium ions from passing through it. Nitrate ions are attracted to a negatively charged membrane and diffuse across the membrane into a clean water stream via diffusion. A majority of the uranium ions are retained in the feed stream.

In some implementations of the Diffusion Dialysis system, multiple cells are stacked in series such that the above-described process is continued through the membrane vessels 200 connected in series. As the feed stream flows down the stack of cells, the feed stream becomes metal rich and acid poor. Additionally, as the water stream flows down the stack of cells, the water stream becomes acid rich with very little uranium contamination. In some implementations, the stack of membrane vessels is optimized to produce a Dialysate with a nitrate/uranium molar ratio of less than 1.7 (<1.7). The two outputs of the process are a dialysate and a recycle acid.

Referring to FIG. 2C, the concentrated uranyl nitrate solution enters at the right of the process, and the distilled water product enters from the left. The two streams flow counter currently from stage to stage within the Diffusion Dialysis system. The concentrated uranyl nitrate solution is depleted in acid and exits the process to the left as dialysate. The distilled water product is loaded with acid and exits to the right as recycle acid. The concentration gradient in a countercurrent process remains relatively constant from stage to stage. For example, the concentrated uranyl nitrate solution is loaded with acid at Stage A_{N+1}, and the water is loaded at Stage ON.

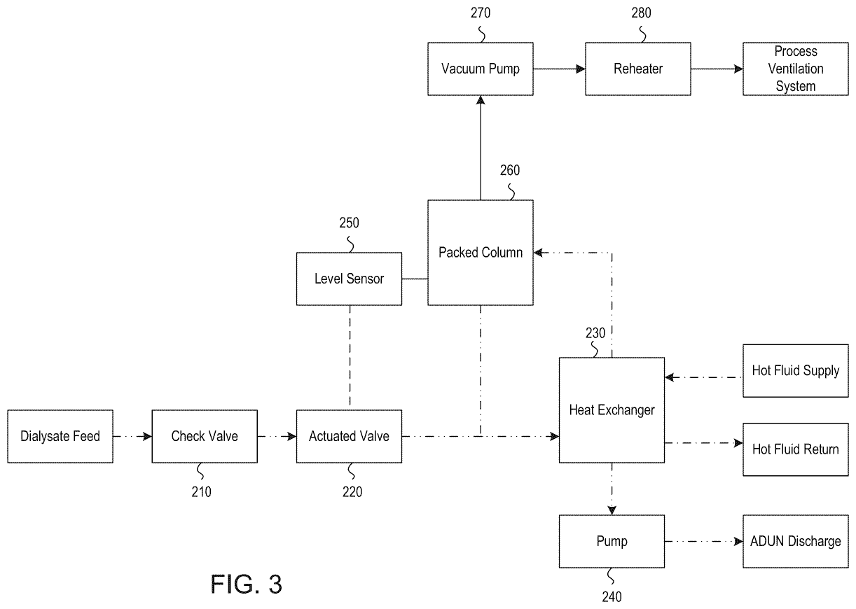

FIG. 3 illustrates one form of a Product Evaporation System. In some implementations, the Produce Evaporation System of FIG. 3 receives a dialysate stream from a Diffusion Dialysis System, such as the Diffusion Dialysis System described above in conjunction with FIGS. 2A to 2C, and concentrates the dialysate stream.

The Produce Evaporation System of FIG. 3 may operate similar to the Feed Evaporation System described above in conjunction with FIG. 1. However, one difference is that a vacuum is provided by a vacuum pump 270 and all of the distillate is discharged as water vapor after going through a reheater 280.

An output of the Produce Evaporation System of FIG. 3 via pump 240 is acid deficient uranyl nitrate that may be used for fuel fabrication.

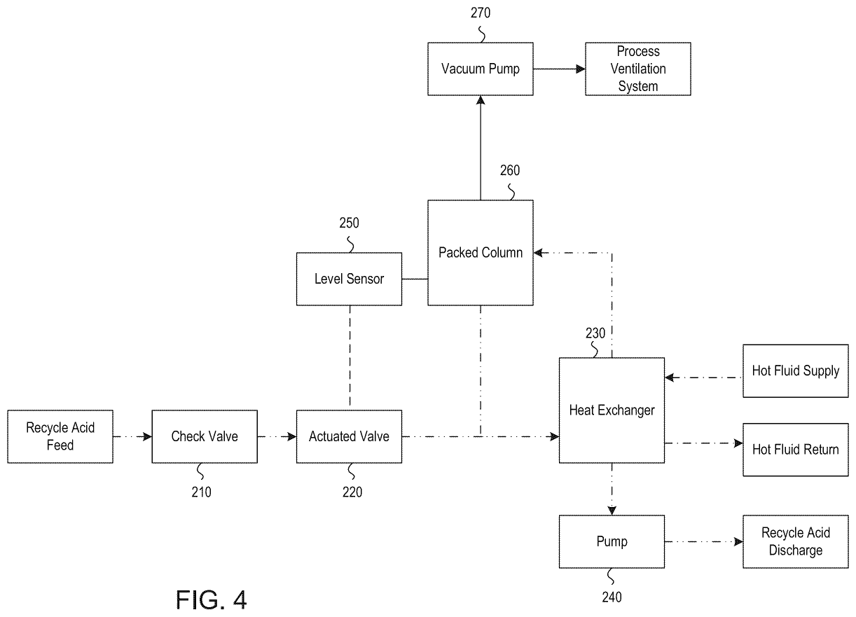

FIG. 4 illustrates one form of a Recovery Evaporation System. In some implementations, the Recovery Evaporation System of FIG. 4 receives a recycle acid stream from a Diffusion Dialysis System, such as the Diffusion Dialysis System described above in conjunction with FIGS. 2A to 2C, and concentrates the recycle acid stream.

The Recovery Evaporation System of FIG. 4 may operate similar to the Product Evaporation System described above in conjunction with FIG. 3. An output of the Recovery Evaporation System is a recycle acid stream that may be used for fuel fabrication.

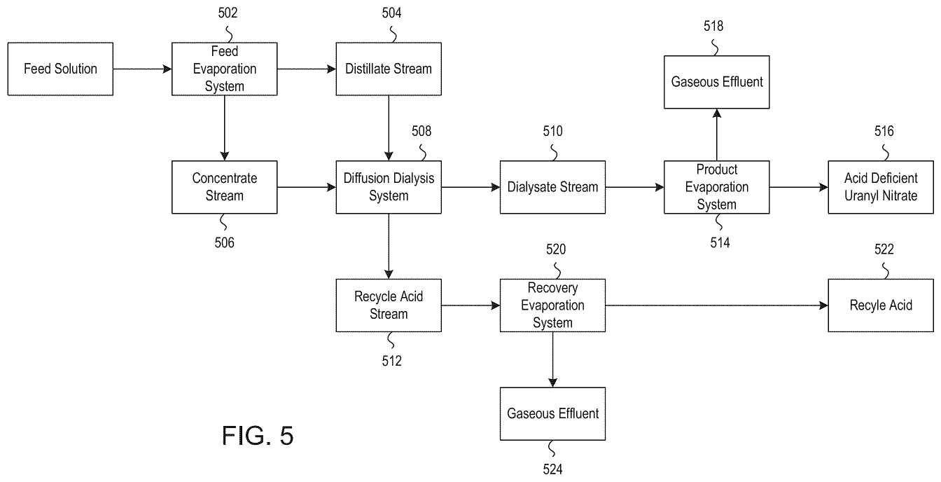

FIG. 5 illustrates one form of an overall system for producing acid deficient uranyl nitrate from a dilute uranyl nitrate solution. As discussed above in conjunction with FIG. 1, a Feed Evaporation System 502 receives a feed solution and produces a distillate stream 504 and a concentrate stream 506.

A Diffusion Dialysis System 508 receives the distillate stream 504 and the concentrate stream 506. As discussed above in conjunction with FIGS. 2A-2C, the Diffusion Dialysis System 506 flows the distillate stream 504 in a first direction and flows the concentrate stream 506 in a second counter direction across a plurality of an anionic membranes to promote nitrate migration from the concentrate stream into the distillate stream.

Processing the distillate stream 504 and the concentrate stream 506 in this manner results in the Diffusion Dialysis System 508 generating a dialysate stream 510 and a recycle acid stream 512.

A Product Evaporation System 514 receives the dialysate stream 510. As discussed above in conjunction with FIG. 3, the Product Evaporation System 514 processes the dialysate stream 510 to provide Acid Deficient Uranyl Nitrate 516 and gaseous effluent (water vapor) 518.

A Recovery Evaporation System 520 receives the recycle acid stream 512. As discussed above in conjunction with FIG. 4, the Recovery Evaporation System 520 processes the recycle acid stream 512 to provide Recycle Acid 522 and gaseous effluent (water vapor) 524.

Systems and methods for producing acid deficient uranyl nitrate from a dilute uranyl nitrate solution have been described above in conjunction with FIGS. 1-5. Although certain implementations of the disclosure have been specifically described herein, it will be apparent to those skilled in the art to which the disclosure pertains that variations and modifications of the various implementations shown and described herein may be made without departing from the spirit and scope of the present disclosure.

1. A system comprising:
a feed evaporation system configured to receive a feed stream and to boil off water, under vacuum, from the feed stream to produce a concentrated uranyl nitrate solution and a distilled water product; and
a diffusion dialysis system configured to accept the concentrated uranyl nitrate solution and the distilled water product; to counter flow the concentrated uranyl nitrate solution and the distilled water product across a plurality of membrane vessels to promote nitrate migration from the concentrated uranyl nitrate solution to the distilled water; and to produce a dialysate stream and a recycle acid stream.

2. The system of claim 1, wherein the feed stream comprises a product of a solvent extraction process used to recycle spent nuclear fuel.

3. The system of claim 1, wherein the feed stream comprises a recovery stream from fuel fabrication activities other than a solvent extraction process used to recycle spent nuclear fuel.

4. The system of claim 1, wherein the membrane vessels of the plurality of membrane vessels are connected in series.

5. The system of claim 1, wherein each membrane vessel comprises an anionic membrane configured to allow nitrate ions to pass through it and to prevent uranium ions from passing through it.

6. The system of claim 1, wherein the plurality of membrane vessels is configured to produce the dialysate stream with a nitrate/uranium molar ratio of less than 1.7.

7. The system of claim 1, further comprising:
a product evaporation system configured to receive the dialysate stream from the diffusion dialysis system and to concentrate the dialysate stream.

8. The system of claim 1, further comprising:
a recovery evaporation system configured to receive the recycle acid stream from the diffusion dialysis system and to concentrate the recycle acid stream.

9. A method comprising:
boiling, at a feed evaporation system, under vacuum, water off from a feed stream to produce a concentrated uranyl nitrate solution and a distilled water product; and
counter flowing, at a diffusion dialysis system, the concentrated uranyl nitrate solution and the distilled water product across a plurality of membrane vessels to promote nitrate migration from the concentrated uranyl nitrate solution to the distilled water, and producing a dialysate stream and a recycle acid stream.

10. The method of claim 9, wherein the feed stream comprises a product of a solvent extraction process used to recycle spent nuclear fuel.

11. The method of claim 9, wherein the feed stream comprises a recovery stream from fuel fabrication activities other than a solvent extraction process used to recycle spent nuclear fuel.

12. The method of claim 9, wherein the membrane vessels of the plurality of membrane vessels are connected in series.

13. The method of claim 9, wherein each membrane vessel comprises an anionic membrane configured to allow nitrate ions to pass through it and to prevent uranium ions from passing through it.

14. The method of claim 9, wherein the plurality of membrane vessels are configured to produce the dialysate stream with a nitrate/uranium molar ratio of less than 1.7.

15. The method of claim 9, further comprising:
concentrating, at a product evaporation system, the dialysate stream.

16. The method of claim 9, further comprising:
Concentrating, at a recovery evaporation system, the recycle acid stream.
